(19) United States
(12) Patent Application Publication
(10) Pub. No.: US 2015/0372442 A1
(43) Pub. Date: Dec. 24, 2015

(54) ARCHITECTURE FOR HIGH POWER FIBER LASER

(71) Applicant: OFS Fitel, LLC, Norcross, GA (US)

(72) Inventors: Hao Dong, Bridgewater, NJ (US); William R Holland, Upper Black Eddy, PA (US); Jerome C Porque, Bridgewater, NJ (US); Sean Sullivan, Keansburg, NJ (US); Thierry F Taunay, Bridgewater, NJ (US)

(21) Appl. No.: 14/609,640

(22) Filed: Jan. 30, 2015

Related U.S. Application Data
(60) Provisional application No. 61/934,168, filed on Jan. 31, 2014.

(51) Int. Cl. H01S 3/067; H01S 3/0941; H01S 3/16; H01S 3/094

(52) U.S. Cl. CPC H01S 3/06708; H01S 3/094042; H01S 3/0941; H01S 3/1618

(57) ABSTRACT

A tapered fiber bundle (TFB) with a brightness reduction (R) that is between 0 and approximately 0.65 (or 65%), where R=(1−(dᵢ/dₐ)²), dᵢ is an ideal output diameter, and dₐ is an actual output diameter. The TFB is optically coupled to a gain fiber with a mode field diameter (MFD) that is between approximately 13 micrometers and approximately 25 micrometers.

### CROSS REFERENCE TO RELATED APPLICATIONS

This application claims the benefit of U.S. provisional patent application Ser. No. 61/934,168, filed 2014 Jan. 31, by Porque, and having the title “Fiber Architecture for High Power Fiber Laser,” which is incorporated herein by reference in its entirety. This application also incorporates by reference in its entirety, U.S. patent application Ser. No. 14/010,825, filed 2013 Aug. 27, by Taunay, and having the title “Gain-Producing Fibers with Increased Cladding Absorption While Maintaining Single-Mode Operation.”

### BACKGROUND

1. Field of Disclosure

The present disclosure relates generally to optics and more particularly to fiber optics.

2. Description of Related Art

Fiber lasers are often used in high-power optical applications. Unfortunately, competing optical characteristics make it difficult to design systems at increasingly higher power levels.

### SUMMARY

The present disclosure provides for high-power fiber lasers. Briefly described, one embodiment comprises a tapered fiber bundle (TFB) with a brightness reduction (R) that is between 0 and approximately 0.65 (or 65%), where: R=(1−(dᵢ/dₐ)²); dᵢ is an ideal output diameter (which would result in R=0); and dₐ is an actual output diameter. The TFB is optically coupled to a gain fiber with a mode field diameter (MFD) that is between approximately 13 micrometers and approximately 25 micrometers.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram showing one embodiment of a fiber laser system using a forward pumping configuration.

FIG. 2 is a block diagram showing one embodiment of a fiber laser system using a bidirectional pumping configuration.

FIG. 3 is a graph showing slope efficiency for the system of FIG. 1.

FIG. 4 is a graph showing slope efficiency for the system of FIG. 2.

FIG. 5 is a graph showing Raman signal separation for the system of FIG. 1.

FIG. 6 is a graph showing Raman signal separation for the system of FIG. 2.

FIG. 7 is a graph showing measured pump power transmission as a function of numerical aperture (NA) for tapered fiber bundles (TFB) with different output fiber diameters.

### DETAILED DESCRIPTION OF THE EMBODIMENTS

High power fiber lasers are usually pumped using laser diodes with pigtailed output fiber. As pump power increases, the fiber lasers can reach correspondingly-high power levels, even up to several kilowatts (kW). Pump diode modules can achieve higher pump power by usually increasing numerical aperture (NA) of the output fiber pigtails, increasing core diameters of fiber pigtails, or both. Unfortunately, increasing NA or core diameter reduces brightness. As a result, some of the benefits associated with higher pump power are largely negated because the higher NA or larger core diameter reduces the amount of pump power that can be coupled into the fiber laser gain fiber. This, in turn, results in a reduction of the number of available input pump ports or, even worse, greater pump loss and eventual failure due to heating caused by the lost pump light.

One way to ameliorate reduction in brightness is to increase the diameter of the gain fiber, thereby accommodating the brightness of the pump light. However, an increase in gain-fiber diameter translates to lower cladding absorption, thereby requiring longer fiber lengths in order to absorb the pump light. Since longer fiber lengths correspond to detrimental nonlinear effects, it is undesirable to have very long fiber lengths.

Cladding absorption can be increased by increasing gain-dopant concentrations or increasing the dimensions of the gain-doped regions. Unfortunately, this results in crystallization and/or photo darkening. Although these detrimental effects can be somewhat remedied by increasing co-dopant concentrations (e.g., increasing concentrations of Aluminum (Al), Phosphorous (P), Germanium (Ge), etc.), an increase in co-dopant concentration alters the refractive index of the material and, therefore, undesirably changes the properties of the waveguide and splice performances. For example, a high core index typically reduces mode field diameter (MFD).

Each of these effects degrades the efficiency of the fiber laser and impairs reliability at high power levels. Larger core areas lead to greater non-single-mode behavior, which occurs at wavelengths below the single-mode cut-off wavelength. The non-single-mode behavior degrades beam quality, induces beam instability, and can ultimately result in catastrophic damage. At bottom, for nearly every beneficial change in one fiber parameter, there is a corresponding detrimental effect on another fiber parameter, thereby increasing the complexity of the design and production of fiber lasers.

In order to take full advantage of high power pump modules for kW-level output powers while maintaining single-mode operation and reaching optimal efficiency, this disclosure provides for a gain fiber that is optically coupled to a tapered fiber bundle (TFB) that combines pump power provided by several pump diode modules. One embodiment of the system comprises a TFB with a brightness reduction (R) that is between 0 and approximately 0.65 (or 65%), where R is defined as (1−(dᵢ/dₐ)²), dᵢ is an ideal output diameter (which would result in R=0), and dₐ is an actual output diameter. The gain fiber has a mode field diameter (MFD) that is between approximately 13 micrometers and approximately 25 micrometers.

Having generally described the particular technological need and the inventive concept, reference is now made in detail to the description of the embodiments as illustrated in the drawings. While several embodiments are described in connection with these drawings, there is no intent to limit the disclosure to the embodiment or embodiments disclosed herein. On the contrary, the intent is to cover all alternatives, modifications, and equivalents.

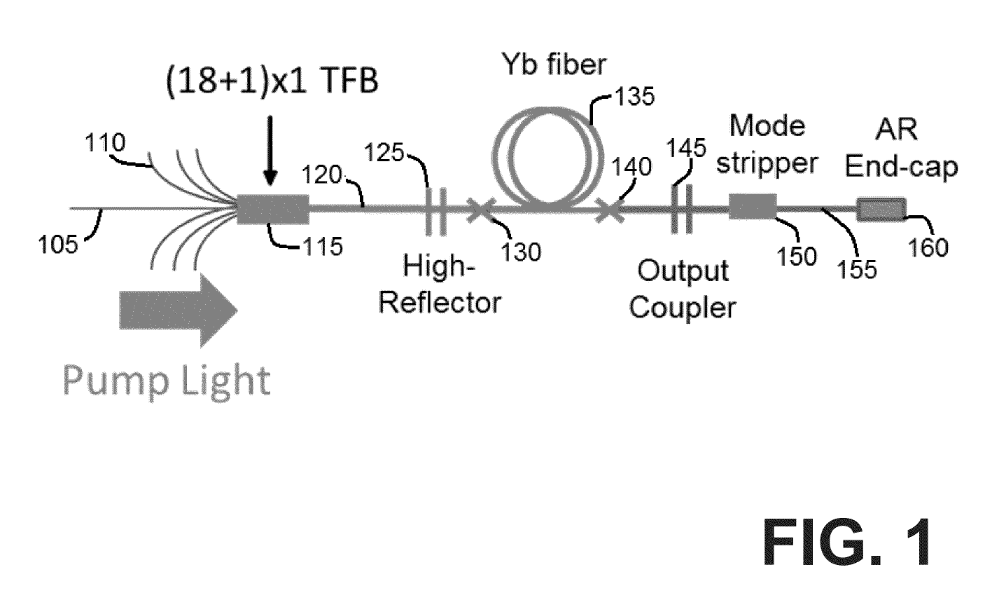

FIG. 1 is a block diagram showing one embodiment of a fiber laser system using a forward pumping configuration. The embodiment of FIG. 1 comprises a TFB 115 with multiple pump ports 110, one (1) signal port 105, and one (1) output fiber 120. The specific embodiment of FIG. 1 shows the TFB 115 as having eighteen (18) pump ports 110 and one (1) signal port 105, which is abbreviated as a (18+1)×1 TFB 115.

The (18+1)×1 TFB 115 is designed to maintain brightness of the pump light. Generally, the ability for a waveguide to handle brightness is represented as the product of numerical aperture (NA) and waveguide dimension (d) (i.e., NA×d). Given nineteen (19) fibers, each with an outer diameter of 125 micrometers (or micrometers), fusing and bundling these 19 fibers results in a structure of equivalent circular diameter of 545 micrometers without a significant change in NA. When the fused bundle is tapered, the NA increases as a result of that taper. Ignoring effects of input-fiber cladding and irregularities associated with real devices, brightness is conserved for a tapered device that has an input NA of 0.18 and an output NA of 0.45, which is spliced to a fiber with an ideal diameter (dᵢ) of 218 micrometers. Deviations from dᵢ reduce brightness. For example, if the actual output diameter (dₐ) is smaller than dᵢ, then some fraction of light will exceed the NA of the output fiber. Conversely, if dₐ is larger than dᵢ, then pump brightness is sacrificed. Consequently, brightness reduction (R) can be represented by the equation:

R=1−(dᵢ/dₐ)² [Eq. 1].

As shown from Eq. 1, there is no brightness reduction when the actual output diameter is coterminous with the ideal output diameter.

Returning to FIG. 1, the output fiber 120 of the (18+1)×1 TFB 115 has a high reflector (HR) 125, which can be a fiber Bragg grating. The HR 125 is spliced 130 to one end of a gain fiber 135. The embodiment of FIG. 1 shows the gain fiber 135 to be Ytterbium (Yb) doped. Preferably, the Yb-doped fiber 135 has a minimum bend radius of approximately 50 millimeters (mm). Also, those skilled in the art will understand that the gain-dopant need not be Yb but may also be Erbium (Er), Thulium (Tm), Neodymium (Nd), Holmium (Ho), any other laser gain medium, or any combination of gain media that can workably be combined by those having skill in the art. Furthermore, it should be appreciated by those having skill in the art that the gain fiber 135 can be an amorphous silica fiber or a crystalline fiber.

Continuing with FIG. 1, the Yb-doped fiber 135 is optically coupled to a fiber with an output coupler (OC) 145, thereby creating a resonant cavity between the HR 125 and the OC 145. The embodiment of FIG. 1 further comprises a mode stripper 150, a delivery fiber (e.g., single-mode, multimode, multimoded with light launched to the fundamental mode via a mode field adaptor) 155, and an end-cap 160 placed in series after the OC 145.

For clarity, specific values are provided with reference to the embodiment of FIG. 1. The TFB 115 comprises one (1) central signal leg 105 and eighteen (18) pump ports 110, with each pump port 110 having a 125-micrometer outer diameter and a 110-micrometer core diameter. Insofar as the nineteen (19) ports (18 pump and 1 signal) are arranged in a closely-packed configuration, the effective input diameter is approximately 545 micrometers. A 250-micrometer diameter TFB output fiber 120 with a low-index polymer coating provides a maximum NA of 0.45 at the output. Given these parameters, dᵢ is mathematically calculated as:

dᵢ=(0.18/0.45)*545 micrometers=218 micrometers

From dᵢ=218 micrometers and dₐ=250 micrometers, R is calculated to be approximately 0.24 (or 24%). When the pump light NA is 0.21, then dᵢ=254 micrometers, thereby resulting in R being approximately zero (0). This suggests that the TFB 115 exhibits some loss of brightness in maintaining a high throughput.

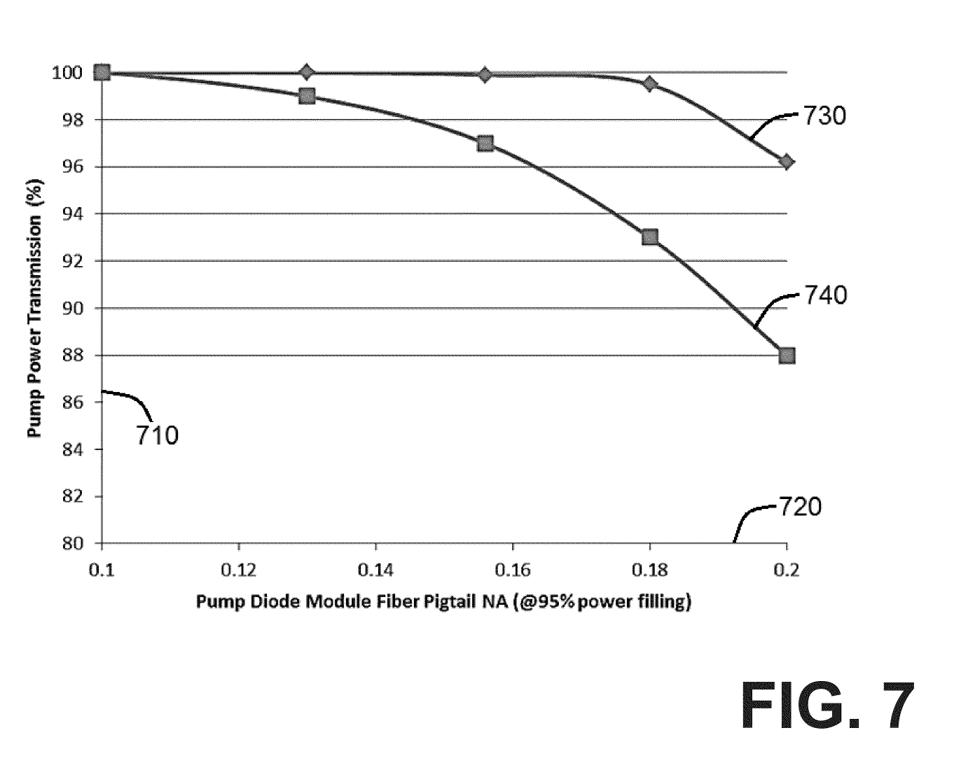

As shown in the plot 730 of FIG. 7 (graphing the pump power transmission in percent (%) 710 as a function of pump fiber pigtail NA (at 95% power filling) 720), a standard fiber pigtail with a maximum NA of 0.2 maintains a higher-than-95% transmission over the full range of NA, exhibiting only a minor loss at NA of 0.18.

If the TFB output fiber 120 has a 200-micrometer diameter (as shown in plot 720 of FIG. 7), then transmission is reduced to 96% at an output NA of approximately 0.165 (for R being approximately 0). Consequently, an R of approximately 0.385 (or 38.5%) maintains a transmission that is greater than 99%. Thus, as shown in FIG. 7, the TFB 115 sacrifices brightness to achieve high throughput, thereby exacerbating any problems caused by larger gain fiber diameters and higher pump powers that cause lower brightness.

From these examples, one can appreciate the competing parameters that must be considered in optimizing the design and fabrication of fiber lasers. The TFB 115 cannot have a taper ratio (defined as the ratio of the input diameter to the output diameter) that is too high because this will reduce TFB transmission and cause reliability problems and inefficiencies associated with dissipating lost energy. Conversely, the TFB 115 cannot have a taper ratio that is too low because this will result in an output-fiber diameter being too large, thereby resulting in a longer fiber with larger nonlinear impairments. Also, the core diameter or the MFD cannot be too high because this will cause the fiber to become multimoded or too sensitive to external perturbations and bending. Conversely, the core diameter or the MFD cannot be too low because this will also result in a longer fiber with larger nonlinear impairments. In addition to these competing parameters, fibers with larger MFD are more difficult to fabricate, which makes it desirable to maintain MFD as low as possible. Also, since concentrations of rare-earth dopants affects performance, it is desirable to fabricate a laser with a typical cavity length, which is approximately 20 meters (m), to achieve an output power of approximately 2 kW. Of course, as one can appreciate, the desirable output power can range from between approximately 500 W to approximately 10 kW.

When all of these factors are considered, R is preferably less than approximately 0.65. More preferably, R in the range of approximately 0.2 to approximately 0.65 and, even more preferably, in the range of approximately 0.4 to approximately 0.65. Additionally, MFD between approximately 13 micrometers and approximately 25 micrometers is preferred, with a narrower range of approximately 13 micrometers to approximately 18 micrometers being more preferred.

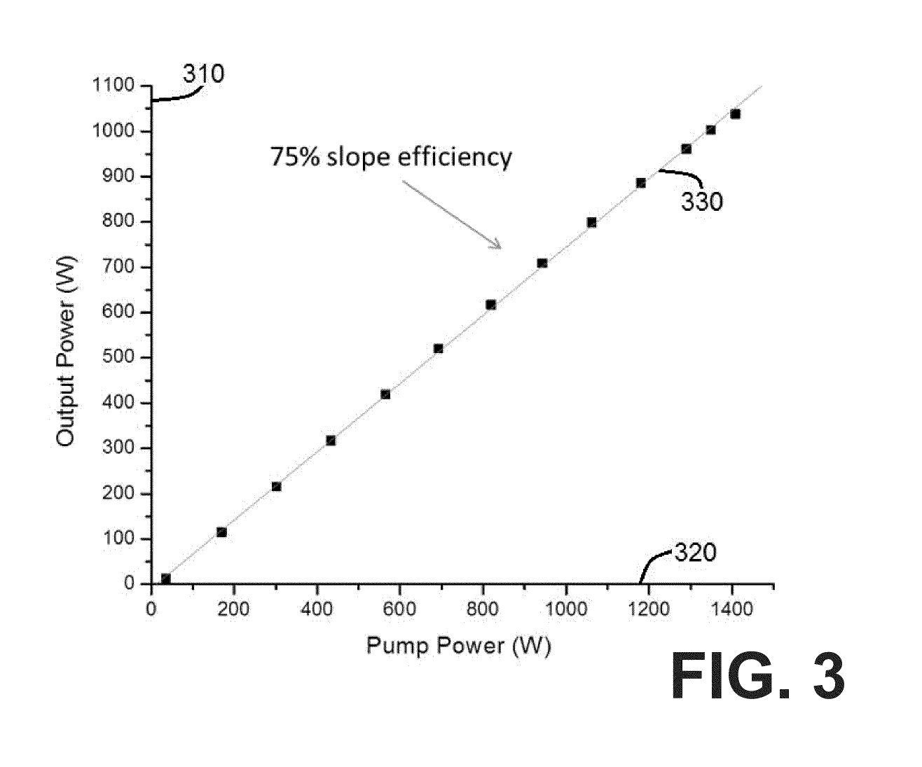

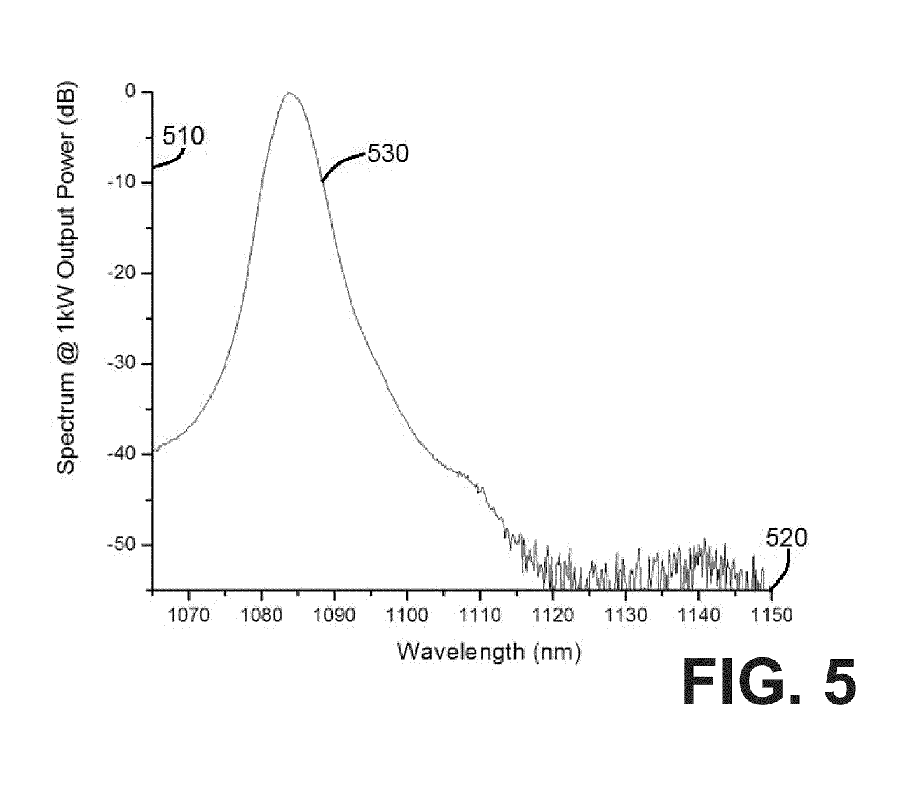

With these parameters in mind, FIG. 3 shows the slope efficiency 330 of the forward pumped system of FIG. 1, plotting output power in Watts (W) 310 as a function of input pump power (W) 320. FIG. 5 shows the Raman signal separation 530 for the system of FIG. 1, plotting the spectrum (in decibels (dB)) 510 as a function of wavelength (in nanometers (nm)) 520. The data in FIGS. 3 and 5 were obtained by pumping a Yb-doped fiber laser with ten (10) 140 W pump diode modules, each operating at a wavelength of approximately 915 nm. The system of FIG. 1 exhibits a 75% efficiency (FIG. 3) and the cutoff wavelength for the Yb-doped fiber 135 is less than 1100 nm for an operating wavelength of 1084 nm (as shown in FIG. 5). It should be appreciated that, depending on the gain dopant, the pump wavelength can range from between approximately 900 nm and approximately 1020 nm, and the operating wavelength can range from between approximately 975 nm and approximately 1180 nm. Furthermore, it should be appreciated that the pump diodes can individually produce approximately 50 W or more, or collectively up to approximately 15 kW.

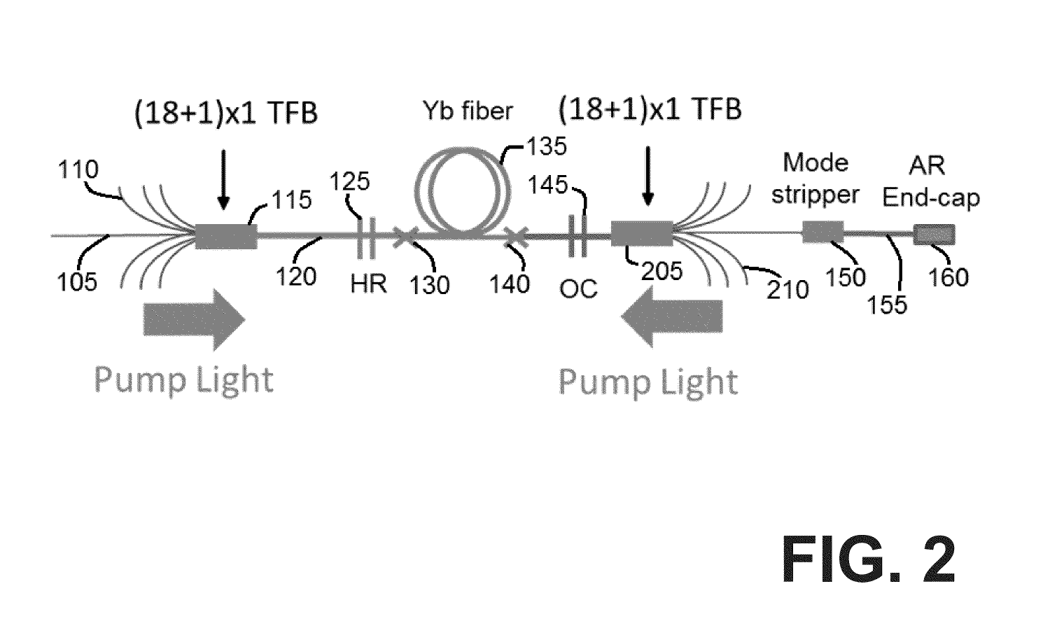

While a forward-pumping configuration is shown in FIG. 1, it should be appreciated that a bidirectional pumping configuration can also be implemented. FIG. 2 is a block diagram showing one embodiment of a fiber laser system using a bidirectional pumping configuration.

Insofar as the pump ports 110, signal port 105, output fiber 120, TFB 115, HR 125, gain fiber 135, OC 145, mode stripper 150, delivery fiber 155, and end-cap 160 have been described with reference to FIG. 1, further discussion of those components is omitted with reference to FIG. 2. Unlike FIG. 1, the embodiment of FIG. 2 also comprises a second (18+1)×1 TFB 205 located serially between the OC 145 and the mode stripper 150. The second TFB 205 comprises multiple pump ports 210, which provide pump power to the TFB 205 (similar to how the pump ports 110 provide power to the forward TFB 115). Employing both TFB 205 and TFB 115 permits bidirectional pumping of the gain fiber 135.

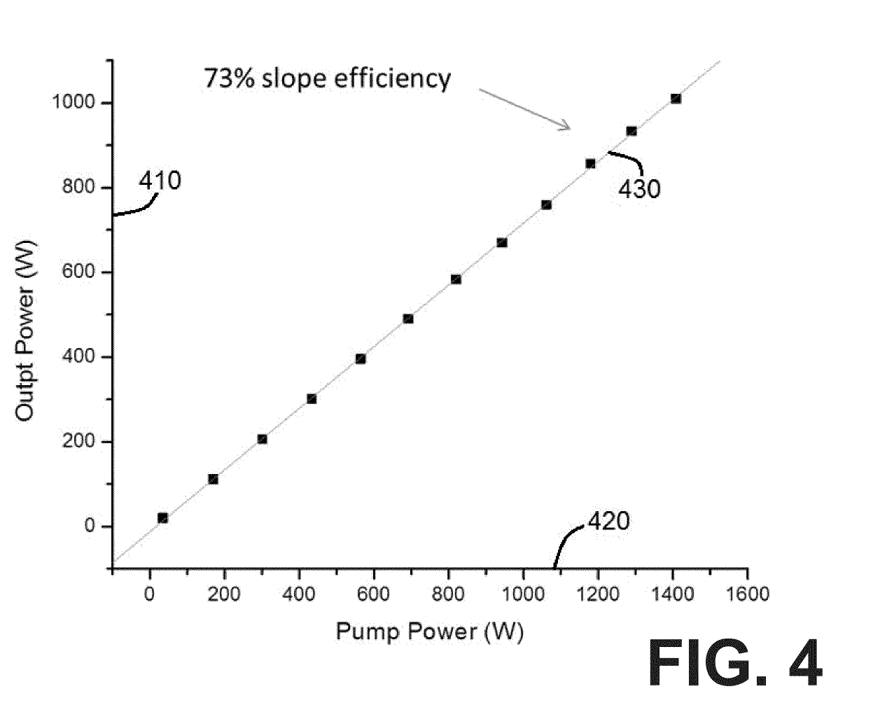

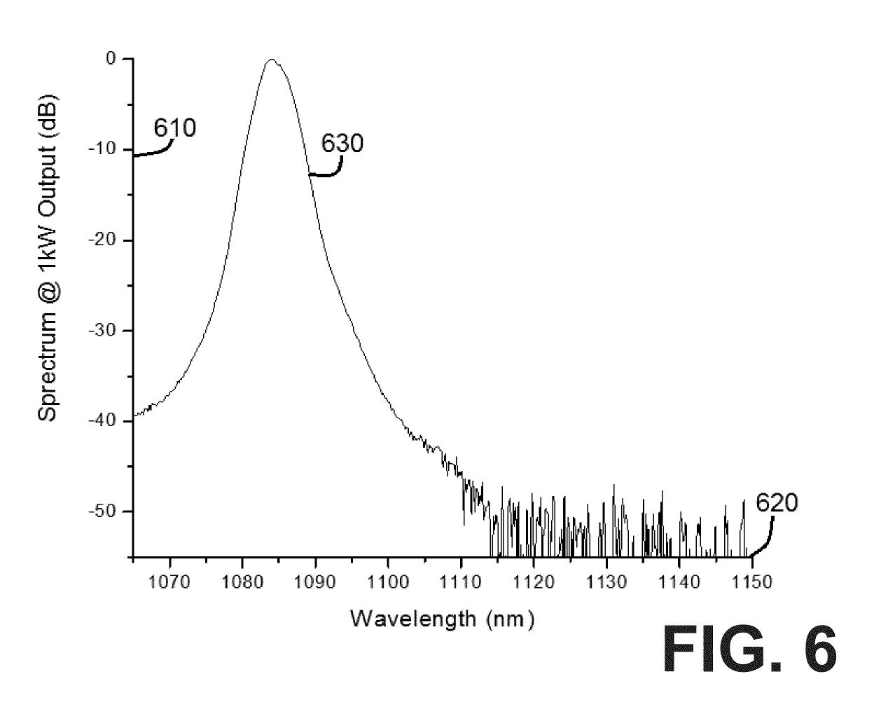

The measured optical performance for the bidirectional-pumping configuration of FIG. 2 is shown in FIGS. 4 and 6. In other words, similar to how FIG. 3 shows a graph of slope efficiency for the forward-pumping embodiment of FIG. 1, FIG. 4 shows slope efficiency for the bidirectional-pumping embodiment of FIG. 2. Also, similar to how FIG. 5 shows a graph of the Raman signal separation in the forward-pumping embodiment of FIG. 1, FIG. 6 shows Raman signal separation for the bidirectional-pumping embodiment of FIG. 2. Insofar as the implications of FIGS. 4 and 6 are clear in view of the explanation of FIGS. 3 and 5, further discussions of FIGS. 4 and 6 are omitted here.

As seen from the embodiments of FIGS. 1 through 7, careful consideration of competing parameters permits the systems of FIGS. 1 and 2 to take full advantage of high power pump modules for kW-level output powers while maintaining single-mode operation and reaching optimal efficiency (M2˜1.05). Specifically, this disclosure provides for a gain fiber with a MFD that is between approximately 13 micrometers and 25 micrometers, with the gain fiber being optically coupled to a TFB with R between 0 and approximately 0.65.

Any process descriptions or blocks in flow charts should be understood as representing modules, segments, or portions of code which include one or more executable instructions for implementing specific logical functions or steps in the process, and alternate implementations are included within the scope of the preferred embodiment of the present disclosure in which functions may be executed out of order from that shown or discussed, including substantially concurrently or in reverse order, depending on the functionality involved, as would be understood by those reasonably skilled in the art of the present disclosure.

Although exemplary embodiments have been shown and described, it will be clear to those of ordinary skill in the art that a number of changes, modifications, or alterations to the disclosure as described may be made. For example, while a (18+1)×1 TFB is specifically shown for clarity, it should be appreciated that the TFB can be configured with different numbers of pump input ports. All such changes, modifications, and alterations should therefore be seen as within the scope of the disclosure.

What is claimed is:

1. A system for operating in a single-mode regime, the system comprising:
a gain-dopant being one selected from the group consisting of: Ytterbium (Yb); Erbium (Er); Thulium (Tm); Neodymium (Nd); Holmium (Ho); and combinations thereof;
a gain fiber comprising the gain-dopant, the gain fiber having a mode field diameter (MFD) between approximately 13 micrometers and approximately 25 micrometers, the gain fiber being one selected from the group consisting of: an amorphous silica fiber; and a crystalline fiber; and
a combiner optically coupled to the gain fiber, the combiner comprising an ideal output diameter (dᵢ), the combiner further comprising an actual output diameter (dₐ), the combiner further comprising a brightness reduction (R=(1−(dᵢ/dₐ)²), R being between 0 and approximately 0.65.

2. The system of claim 1, R further being between approximately 0.2 and approximately 0.65.

3. The system of claim 2, R further being between approximately 0.4 and approximately 0.65.

4. The system of claim 1, the MFD further being between approximately 13 micrometers and approximately 18 micrometers.

5. A system for operating in a single-mode regime, the system comprising:
a gain-dopant;
a gain fiber comprising the gain-dopant, the gain fiber further having a mode field diameter (MFD) between approximately 13 micrometers and approximately 25 micrometers; and
a combiner optically coupled to the gain fiber, the combiner comprising an ideal output diameter (dᵢ), the combiner further comprising an actual output diameter (dₐ), the combiner further comprising a brightness reduction (R=(1−(dᵢ/d^{a})²), R being between 0 and approximately 0.65.

6. The system of claim 5, further comprising:
pump diodes optically coupled to the combiner, the pump diodes providing between approximately 50 Watts (W) and approximately 15 kiloWatts (kW) of pump power.

7. The system of claim 6, each pump diode providing approximately 140 W of pump power, each pump diode having an operating wavelength of between approximately 900 nanometers (nm) to approximately 1020 nm.

8. The system of claim 5, R further being between approximately 0.2 and approximately 0.65.

9. The system of claim 5, R further being between approximately 0.4 and approximately 0.65.

10. The system of claim 5, the MFD being between approximately 13 micrometers and approximately 18 micrometers.

11. The system of claim 5, the gain fiber having a minimum bend radius of approximately 50 millimeters (mm).

12. The system of claim 5, the gain fiber being a Ytterbium (Yb) doped fiber, the Yb-doped fiber having an operating wavelength between approximately 975 nanometers (nm) and approximately 1180 nm, the Yb-doped fiber further having a cutoff wavelength of approximately 1100 nm.

13. The system of claim 5, the gain-dopant being one selected from the group consisting of: Ytterbium (Yb); Erbium (Er); Thulium (Tm); Neodymium (Nd); Holmium (Ho); and combinations thereof.

14. The system of claim 5, the combiner comprising:
inputs, each input comprising an outer diameter and a core diameter, the outer diameter being approximately 125 micrometers, the core diameter being approximately 110 micrometers; and
an output comprising an outside diameter, the outside diameter being approximately 250 micrometers.

15. The system of claim 5, the combiner comprising:
inputs, each input comprising an outer diameter and a core diameter, the outer diameter being approximately 125 micrometers, the core diameter being approximately 110 micrometers; and
an output comprising an outside diameter, the outside diameter being approximately 200 micrometers.

16. A system for operating in a single-mode regime, the system comprising:
a gain fiber comprising a gain-dopant, the gain fiber having a mode field diameter (MFD) between approximately 13 micrometers and approximately 25 micrometers; and
a combiner optically coupled to the gain fiber, the combiner further comprising a brightness reduction defined by R, wherein:
R=(1−(dᵢ/dₐ)²);
dᵢ is an ideal output diameter; and
dₐ is an actual output diameter.

17. The system of claim 16, R being between approximately 0 and approximately 0.65.

18. The system of claim 16, the MFD being between approximately 13 micrometers and approximately 18 micrometers.

19. The system of claim 16, further comprising:
pump diodes optically coupled to the combiner, the pump diodes providing between approximately 50 Watts (W) and approximately 15 kiloWatts (kW) of pump power.

20. The system of claim 16, further comprising means for providing between approximately 50 Watts (W) and approximately 15 kiloWatts (kW) of pump power.
